(19) United States
(12) Patent Application Publication
(10) Pub. No.: US 2022/0153636 A1
(43) Pub. Date: May 19, 2022

(54) COATED ARTICLE AND METHOD FOR MANUFACTURING THE SAME

(71) Applicant: SAINT-GOBAIN GLASS FRANCE, COURBEVOIE (FR)

(72) Inventors: Jin Woo HAN, Seoul (KR); Eun Hack JANG, Gunsan-si (KR)

(21) Appl. No.: 17/442,488

(22) PCT Filed: Apr. 24, 2020
(86) PCT No.: PCT/KR2020/005447

§ 371 Date: Sep. 23, 2021

(30) Foreign Application Priority Data
Apr. 26, 2019 (KR) 10-2019-0049250

(51) Int. Cl. C03C 17/36; C03C 17/04

(52) U.S. Cl. CPC C03C 17/3618; C03C 17/04; C03C 17/3626; C03C 2217/77; C03C 2217/281; C03C 2217/228; C03C 2217/216; C03C 17/3639

(57) ABSTRACT

A coated article includes a transparent substrate, a multilayer thin film coating disposed on the transparent substrate, and a patterned area having an enamel coating formed on at least part of the transparent substrate in a predetermined pattern, wherein the multilayer thin film coating includes a first dielectric layer, a metallic functional layer having an infrared ray reflection function, and a second dielectric layer, which are sequentially disposed in a direction away from the transparent substrate, and the patterned area includes the first dielectric layer remaining on the substrate after the second dielectric layer and the metallic functional layer are removed from the multilayer thin film coating, and the enamel coating formed on the first dielectric layer.

### TECHNICAL FIELD

A coated article and a manufacturing method thereof are disclosed. In detail, a coated article including a multilayer thin film coating and an enamel coating, and a manufacturing method thereof, are disclosed.

### BACKGROUND ART

Printed glass substrates are used for multiple purposes, such as, ornamental and/or functional aims in the fields of industrial, office, or residential buildings, glazing for vehicles, or oven doors and refrigerator doors. To control heat, low-emissivity glass is applied to glass substrates. For example, in the case of applying it to an oven door, a low-emissivity coating is applied to at least one side of a glass substrate so as to improve insulation of the oven and prevent burns when a user contacts the oven door.

A low-emissivity glass is a glass on which a low-emissivity layer including a metal having high reflectance in an infrared region such as silver (Ag) is deposited as a thin film. The printed glass substrate may be obtained by applying a dark-colored enamel coating to the glass on which a low-emissivity layer is deposited.

However, in this case, when the enamel coating is formed on the glass on which a low-emissivity layer is deposited, adherence is deteriorated in an interface between the enamel coating and the low-emissivity layer, so peeling off is generated. To solve this, in prior art, a method is forming an enamel coating after mechanically removing a Low-E coating (i.e., an edge deletion) at a portion to which an enamel coating is to be applied, or a chemical method as disclosed in the subsequent Patent Documents 1 and 2, namely, a method for removing the entire Low-E coating through a reaction between the enamel coating and the Low-E coating, is used. However, when the Low-E coating is removed and the enamel coating is then applied as described above, alkali metal ions are spread to the enamel coating from the glass to deteriorate quality of the enamel coating and break a glass network because of the loss of alkali metal, and so on, which problems are happened frequently.

### PRIOR ART DOCUMENT

### Patent Document

1. U.S. Pat. No. 7,323,088 B
2. U.S. Patent Publication 2015/0376935 A

The above information disclosed in this Background section is only for enhancement of understanding of the background of the invention and therefore it may contain information that does not form the prior art that is already known in this country to a person of ordinary skill in the art.

### DISCLOSURE

The present invention has been made in an effort to provide a coated article including an enamel coating with excellent adherence and surface quality even when having a multilayer thin film coating with an infrared ray reflection function therein, and a manufacturing method thereof.

However, tasks to be solved by exemplary embodiments of the present invention may not be limited to the above-described task, and may be extended in various ways within a range of technical scopes included in the present invention.

An exemplary embodiment of the present invention provides a coated article including a transparent substrate, a multilayer thin film coating disposed on the transparent substrate, and a patterned area having an enamel coating formed on at least part of the transparent substrate in a predetermined pattern, wherein the multilayer thin film coating includes a first dielectric layer, a metallic functional layer having an infrared ray reflection function, and a second dielectric layer, which are sequentially disposed in a direction away from the transparent substrate, and the patterned area includes the first dielectric layer remaining on the substrate after the second dielectric layer and the metallic functional layer are removed from the multilayer thin film coating and the enamel coating formed on the first dielectric layer.

The multilayer thin film coating may include a blocking layer laminated on at least one of an upper surface and a lower surface of the metallic functional layer to prevent oxidation of the metallic functional layer.

The first dielectric layer included in the patterned area may prevent diffusion of sodium ions from the transparent substrate.

The first dielectric layer may include a silicon nitride.

The enamel coating may have surface roughness less than 0.5 μm.

The enamel coating may include at least one metal selected from Bi and Zn.

The enamel coating may include a black pigment.

Another embodiment of the present invention provides a manufacturing method of a coated article, including: printing a composition for forming an enamel coating to have a predetermined pattern on at least part of a transparent substrate on which a multilayer thin film coating is formed; and forming a patterned area including an enamel coating by performing a heat treatment on the transparent substrate on which the multilayer thin film coating and the composition for forming an enamel coating are formed, wherein the multilayer thin film coating includes a first dielectric layer, a metallic functional layer having an infrared ray reflection function, and a second dielectric layer in a direction away from the transparent substrate, the metallic functional layer and the second dielectric layer are removed from a portion on which the patterned area is formed by the heat treatment, and the first dielectric layer remains between the enamel coating and the transparent substrate.

The multilayer thin film coating may further include a blocking layer laminated on at least one of an upper surface and a lower surface of the metallic functional layer to prevent oxidation of the metallic functional layer.

The heat treatment may be carried out at a temperature of 500° C. to 720° C.

The composition for forming an enamel coating may include a metal oxide with etching performance on the metallic functional layer.

The metal oxide may be at least one selected from Bi₂O₃ and ZnO.

The metal oxide may be Bi₂O₃, and a content of Bi₂O₃ may be 55 wt % to 69 wt % in the entire glass frit included in the composition for forming an enamel coating.

The manufacturing method may include a step of measuring resistance of the metallic functional layer so as to confirm removal of the metallic functional layer during the heat treatment, and stopping the heat treatment when resistance of the metallic functional layer is equal to or greater than 100 Ω/m².

The manufacturing method may further include drying and preheating the composition for forming an enamel coating before the heat treatment.

The heat treatment may be a tempering process of the transparent substrate.

Another embodiment of the present invention provides a coated article manufactured by the above-described manufacturing method.

According to the exemplary embodiment of the present invention, the coated article including an enamel coating with excellent adherence and surface quality while installing a multilayer thin film coating with an infrared ray reflection function may be obtained.

### DESCRIPTION OF THE DRAWINGS

FIG. 1 shows a cross-sectional view of a coated article according to an exemplary embodiment of the present invention.

FIG. 2 shows a process for manufacturing a coated article according to another exemplary embodiment of the present invention.

FIG. 3 shows a graph of resistance changes measured in the stage of forming an enamel coating according to exemplary embodiments of the present invention and comparative examples.

FIG. 4 shows photographs of the enamel coating surface according to exemplary embodiments of the present invention and comparative examples.

FIG. 5 shows SEM photographs of a space between enamel coating and transparent substrates according to exemplary embodiments of the present invention and comparative examples.

### MODE FOR INVENTION

It will be understood that, although the terms first, second, third, etc. may be used herein to describe various elements, components, regions, layers, and/or sections, they are not limited thereto. These terms are only used to distinguish one element, component, region, layer, or section from another element, component, region, layer, or section. Thus, a first element, component, region, layer, or section discussed below could be termed a second element, component, region, layer, or section without departing from the teachings of the present invention.

The technical terms used herein are to simply mention a particular exemplary embodiment and are not meant to limit the present invention. An expression used in the singular encompasses an expression of the plural, unless it has a clearly different meaning in the context. In the specification, it is to be understood that terms such as “including”, “having”, etc., are intended to indicate the existence of specific features, regions, numbers, stages, operations, elements, components, or combinations thereof disclosed in the specification, and are not intended to preclude the possibility that one or more other specific features, regions, numbers, operations, elements, components, or combinations thereof may exist or may be added.

When a part is referred to as being “on” another part, it can be directly on the other part or intervening parts may also be present. In contrast, when an element is referred to as being “directly on” another element, there are no intervening elements therebetween.

Unless otherwise defined, all terms used herein, including technical or scientific terms, have the same meanings as those generally understood by those with ordinary knowledge in the field of art to which the present invention belongs. Such terms as those defined in a generally used dictionary are to be interpreted to have the same meanings as contextual meanings in the relevant field of art, and are not to be interpreted to have idealized or excessively formal meanings unless clearly defined in the present application.

Hereinafter, exemplary embodiments of the present invention will be described in detail so that those skilled in the art to which the present invention pertains may easily implement the exemplary embodiments.

As those skilled in the art would realize, the described embodiments may be modified in various different ways, all without departing from the spirit or scope of the present invention.

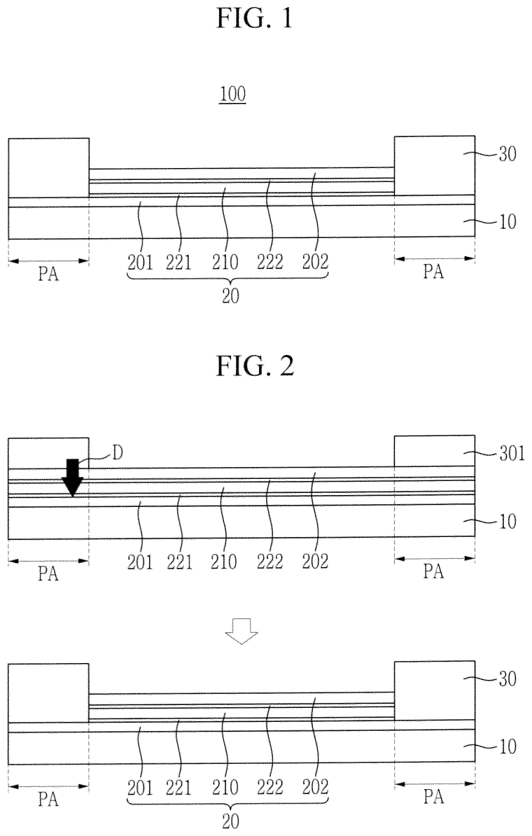

FIG. 1 shows a cross-sectional view of a coated article according to an exemplary embodiment of the present invention.

Referring to FIG. 1, the coated article according to an exemplary embodiment of the present invention includes a transparent substrate 10 and a multilayer thin film coating 20 formed on the transparent substrate 10, and further includes a patterned area (PA) formed on at least part of the transparent substrate 10 as a predetermined pattern.

The transparent substrate 10 is not specifically limited, but it is preferably manufactured of an inorganic material such as glass or an organic material of a polymer matrix.

The multilayer thin film coating 20 includes a first dielectric layer 201, a metallic functional layer 210 having an infrared ray reflection function, and a second dielectric layer 202, which are disposed in a direction away from the transparent substrate 10, and it includes blocking layers 221 and 222 stacked on at least one of an upper surface and a lower surface of the metallic functional layer 210.

The first dielectric layer 201 and the second dielectric layer 202 may include a metal oxide, a metal nitride, or a metal oxynitride. The metal may include at least one of titanium (Ti), hafnium (Hf), zirconium (Zr), niobium (Nb), zinc (Zn), bismuth (Bi), lead (Pb), indium (In), tin (Sn), and silicon (Si). Preferably, it may include a silicon nitride (Si₃N₄).

In the present exemplary embodiment, the first and second dielectric layers 201 and 202 are illustrated to be a single layer, they are not limited thereto, and they may be respectively formed to be a laminated body with more than two layers. Further, Al, etc. may be additionally doped to the first and second dielectric layers 201 and 202. By doping Al, the dielectric layers may be smoothly formed in the manufacturing process. The first and second dielectric layers 201 and 202 may include a doping agent, for example, fluorine, carbon, nitrogen, boron, phosphorus, and/or aluminum. Namely, a target used in a sputtering process is doped with aluminum, boron, or zirconium, thereby improving the optical property of the coating and increasing the formation speed of the dielectric layer by sputtering. When the first and second dielectric layers 201 and 202 include a silicon nitride, zirconium may be doped, and Zr(Si+Zr) may be 10 to 50% in a molar ratio. When the zirconium is doped, a refractive index of the dielectric layer may be increased and transmittance may be increased. In detail, the first and second dielectric layers 201 and 202 may be a zirconium-doped silicon nitride, but are not limited thereto.

The first dielectric layer 201 closest to the transparent substrate 10 among the dielectric layers is formed to extend up to the patterned area (PA), and it is between an enamel coating 30 and the transparent substrate 10 in the patterned area (PA) to prevent diffusion of sodium ions from the transparent substrate 10, and a detailed content will be described together with the later-described patterned area (PA).

The metallic functional layer 210 has an infrared ray (IR) reflection characteristic. The metallic functional layer 210 may include at least one of gold (Au), copper (Cu), palladium (Pd), aluminum (Al), and silver (Ag). In detail, it may include silver or a silver alloy. The silver alloy may include a silver-gold alloy and a silver-palladium alloy.

Here, the metallic functional layer 210 may include a single layer (a single Low-E coating), or may include at least two metallic functional layers. Namely, it is possible to include two or three metallic functional layers, and if needed, four metallic functional layers. For example, when including two metallic functional layers (a double Low-E coating), the multilayer thin film coating includes a first dielectric layer 201, a first metallic functional layer 210, a second dielectric layer 202, a second metallic functional layer (not shown), and a third dielectric layer (not shown), which are disposed in a direction away from the transparent substrate. The configuration of the third dielectric layer may be equivalent to or different from the above-described first and second dielectric layers 201 and 202. In this case, a sum of thicknesses of the first and second metallic functional layers may be 27 to 33 nm. When they are very thin, a solar heat gain coefficient (SHGC) may increase. When they are very thick, the color coordinates of a transmission color may be distant from the blue color.

In an exemplary embodiment of the present invention, blocking layers 221 and 222 stacked on at least one of the upper surface and the lower surface of the metallic functional layer 210 and preventing oxidization of the metallic functional layer 210 may be further included. When there are a plurality of metallic functional layers 210, blocking layers corresponding to the respective metallic functional layers may be further included. FIG. 1 shows that the blocking layers 221 and 222 are stacked on the upper surface and the lower surface of the metallic functional layer 210, but they are not limited thereto, and they may be formed on one of the upper surface and the lower surface. The blocking layers 221 and 222 may include at least one of titanium, nickel, chromium, and niobium. In further detail, they may include a nickel-chromium alloy. In this case, part of chromium may be changed to a nitride during a sputtering process. The thicknesses of the blocking layers 221 and 222 may be 0.5 to 2 nm, respectively.

An over-coating layer (not shown) may be further included on the outermost portion of the multilayer thin film coating 20. Namely, the over-coating layer may be formed on the second dielectric layer 202 in the case of the single Low-E coating, or it may be formed on the third dielectric layer in the case of a double Low-E coating, and when an additional layer is included, it may be formed on the farthest layer from the transparent substrate 10 on the multilayer thin film coating 20. The over-coating layer may be at least one of TiOₓ, TiOₓN_{y}, TiNₓ, and Zr dopants. In further detail, the over-coating layer may include TiZrₓO_{y}N_{z} (here, x is 0.5 to 0.7, y is 2.0 to 2.5, and z is 0.2 to 0.6). By including the over-coating layer, the layers included in the multilayer thin film coating 20 may be prevented from being damaged.

In an exemplary embodiment of the present invention, the patterned area (PA) formed on at least part of the transparent substrate 10 in a predetermined pattern includes an enamel coating 30 for covering the predetermined pattern, and includes a first dielectric layer 201 provided between the enamel coating 30 and the transparent substrate 10.

The enamel coating 30 may appear as a dark color, and it may be formed with various types of patterns depending on its use. For example, it may have a frame or picture frame shape extending along an edge of the coated article 100, it may have a specific shape to have an ornamental effect, and it is not specifically limited.

The enamel coating 30 may include a black pigment and may be formed to be opaque to visible rays. The enamel coating 30 may be made of an organic combination agent acquired by melting of the glass frit. Namely, it may be formed by applying a composition (or a paste) comprising a glass frit, an organic vehicle (or a binder), and a liquid supplemental agent, and drying it, melting it, and cooling it. In this instance, a raw material for manufacturing the glass frit includes a metal oxide including at least one of Bi₂O₃ and ZnO. Therefore, the enamel coating 30 formed therefrom includes a metal oxide including at least one of Bi and Zn. Further, the thickness of the enamel coating 30 may be 5 μm to 30 μm, but is not limited thereto.

A first dielectric layer 201 is disposed between the enamel coating 30 and the transparent substrate 10. The first dielectric layer 201 prevents diffusion of sodium ions from the transparent substrate 10 to the enamel coating 30, thereby improving adherence of the enamel coating 30, and also suppresses generation of bubbles inside the enamel coating 30 during the manufacturing process, thereby improving the surface characteristic of the enamel coating 30.

Particularly, when applying the enamel coating 30 to the transparent substrate 10 on which the multilayer thin film coating 20 including a metallic functional layer 210 is formed, metal sediments are generated as time passes, and the enamel coating 30 is easily peeled off from the metallic functional layer 210, so it is difficult to apply the enamel coating 30 to the transparent substrate 10. To solve this, in the prior art, a method for removing the multilayer thin film coating 20 by a physical method (an edge deletion) or a chemical method from the portion on which the enamel coating 30 is applied, and allowing the enamel coating 30 to directly contact the transparent substrate 10, is proposed. However, when the enamel coating 30 directly contacts the transparent substrate 10, there are many paths for alkali ions like sodium ions to pass through the gaps between glass networks formed on the enamel coating 30, so a movement of the sodium ions passing through the paths from the transparent substrate 10 made of glass increases. Because of this, the glass of the transparent substrate 10 is corroded according to separation of the sodium ions, adhesion of the enamel coating 30 is deteriorated when the network is broken, and the enamel coating 30 is discolored and corroded.

However, according to an exemplary embodiment of the present invention, the metallic functional layer 210 is particularly removed and the first dielectric layer 201 exists between the enamel coating 30 and the transparent substrate 10, so adhesion is not deteriorated since absence of the sediments generated by the metallic functional layer 210, and the movement of the alkali ions (or the sodium ions) is blocked by the first dielectric layer 201, thereby preventing corrosion, discoloring, and deterioration of adhesion of the enamel coating 30 and the transparent substrate 10. In addition, according to an exemplary embodiment of the present invention, the first dielectric layer 201 may be easily formed without an additional process, generation of bubbles may be reduced in the formation process, and surface quality of the enamel coating 30 may be improved. Namely, the enamel coating 30 according to an exemplary embodiment of the present invention has surface roughness of less than 0.5 μm.

A method for manufacturing a coated article according to an exemplary embodiment of the present invention will now be described with reference to FIG. 2.

FIG. 2 shows a process for manufacturing a coated article according to another exemplary embodiment of the present invention.

First, a multilayer thin film coating 20 with a configuration in which a first dielectric layer 201, a first blocking layer 221, a metallic functional layer 210, a second blocking layer 222, and a second dielectric layer 202 are stacked in order is formed on the transparent substrate 10.

Respective layers of the multilayer thin film coating 20 may be formed by a physical vapor deposition (PVD) method such as sputtering.

A composition 301 for forming an enamel coating is printed on at least part of the multilayer thin film coating 20 so as to have a predetermined pattern.

The composition 301 for forming an enamel coating may be in a paste form including a glass frit, a black pigment, and an organic vehicle. Namely, the composition 301 for forming a paste-type enamel coating is printed on the multilayer thin film coating 20 in a preferable form by a method such as screen printing.

Here, the glass frit may include components of the glass frit for forming a general enamel coating, and for example, it may be manufactured from raw materials including SiO₂, B₂O₃, Bi₂O₃, Al₂O₃, ZnO, Na₂O₂, K₂O₃, Li₂O₂, BaO, and MgO. Particularly, to easily melt the layer included in the multilayer thin film coating 20, at least one of metal oxide selected from Bi₂O₃ and ZnO is included as an essential component. In this instance, the metal oxide may be Bi₂O₃, and a content of Bi₂O₃ may be 55 wt % to 69 wt % of the glass frit.

Further, the black pigment represents a component for assigning a desired color to the enamel coating 30, and for example, a chromium-copper oxide or a spinel-type black pigment may be used, but it is not specifically limited, and generally-used ceramic pigments may be appropriately selected and used. In another way, it is possible to realize the black color by the components included in the glass frit instead of an additional pigment.

The glass frit and the black pigment are uniformly dispersed in the organic vehicle. Here, the organic vehicle may be formed of a volatile material, so it may be removed by a preheating or drying process after the composition 301 for forming an enamel coating is printed. The process temperature in this instance is equal to or less than the softening point of the glass frit, the temperature is at which only the organic vehicle can be vaporized, it is selectable depending on the type of the organic vehicle, and for example, the process may be performed at a temperature of 70° C. to 170° C.

A patterned area (PA) including an enamel coating 30 is formed by performing a heat treatment on a laminated body which formed after the organic vehicle removed on the pattern formed by the composition 301 for forming an enamel coating.

The heat treatment may be performed at a temperature of 500° C. to 720° C. While performing the heat treatment at the corresponding temperature, the glass frit included in the composition 301 for forming an enamel coating is melted, and by this, the second dielectric material 202, the metallic functional layer 210, and the blocking layers 221 and 222 in the multilayer thin film coating 20 disposed on the portion corresponding to the patterned area (PA) are dissolved in the melted glass frit as marked with an arrow D of FIG. 2.

Particularly, the heat treatment in this instance proceeds until the first dielectric layer 201 remains in the patterned area (PA), and the second dielectric material 202, the metallic functional layer 210, and the blocking layers 221 and 222 are dissolved and removed.

Here, to confirm that the second dielectric material 202, the metallic functional layer 210, and the blocking layers 221 and 222 are removed and the first dielectric layer 201 remains in the patterned area (PA), a step of measuring resistance of the metallic functional layer 210 is further included. Namely, when the metallic functional layer 210 exists in the patterned area (PA), resistance is measured to be very low because of the conductive metallic functional layer 210, and when the heat treatment proceeds and the metallic functional layer 210 is removed, the conductive layer disappears and measured resistance steeply increases. For example, by stopping the heat treatment when the measured resistance is equal to or greater than 100 Ω/m², the first dielectric layer 201 remains in the patterned area (PA), and the second dielectric material 202, the metallic functional layer 210, and the blocking layers 221 and 222 are removed. Particularly, when the resistance is equal to or greater than 100 Ω/m², some metallic functional layer 210 may remain in an island shape, but most of it is already removed, so the high resistance is generated as described above, and the configuration in which the metallic functional layer 210 is removed and the first dielectric layer 201 remains without an additional confirmation process.

Further, in the process in which the layers included in the multilayer thin film coating 20 are dissolved by the heat treatment, the oxide included in the glass frit reacts with the layers included in the multilayer thin film coating 20, and gases generated as a result of the reaction may remain in the enamel coating 30 and may deteriorate quality of the enamel coating 30. Namely, the bubbles fail to leave the enamel coating 30 and the surface of the enamel coating 30 becomes rough. However, in an exemplary embodiment of the present invention, finally, the first dielectric layer 201 that is the cause of generation of bubbles remaining by reaction with the glass frit does not react but remains, thereby preventing the remaining of bubbles. Therefore, the enamel coating 30 with less surface roughness may be obtained.

Further, a process for reinforcing the transparent substrate 10, Namely, the tempering process, may also be performed together by the heat treatment. Namely, the heat treatment process for forming an enamel coating 30 is performed at the sufficiently high temperature, so the sufficiently reinforced transparent substrate 10 may be obtained without an additional tempering process.

According to the manufacturing method according to an exemplary embodiment of the present invention, the coated article 100 may be obtained by making the first dielectric layer 201 made of a silicon nitride between the enamel coating 30 and the transparent substrate 10 remain in the patterned area (PA) without an additional process, so the enamel coating 30 formed on the transparent substrate 10 including the multilayer thin film coating 20 may provide excellent adherence, suppress internal generation of bubbles, and provide excellent surface quality. In addition, the movement of alkali ions between the transparent substrate 10 and the enamel coating 30 is suppressed thereby preventing the transparent substrate 10 made of glass and the enamel coating 30 from being corroded and discolored.

The present invention will now be described in further detail with reference to an experimental example. However, the experimental example exemplifies the present invention, and the present invention is not limited thereto.

### Experimental Example

A Planitherm Dura Plus (a brand name, a glass substrate to which a single Low-E coating is applied) that is a Low-E glass of Glass Industry Co., Ltd. Korea is prepared as a transparent substrate including a multilayer thin film coating.

Here, the composition for forming an enamel coating including an organic vehicle obtained by mixing the glass frit having the composition expressed in Table 1, ETHOCEL™ STD. 45, ETHOCEL™ STD. 14 (i.e., ethyl cellulose) of Dow Chemical, and butyl carbitol acetate in a ratio of 1.3:1.7:19 is printed on the transparent substrate including the multilayer thin film coating, it is dried for twenty minutes at a temperature of 60° C., it is further dried for twenty minutes at a temperature of 90° C., and it is heat-treated at a temperature of 670° C. to obtain a coated article in which an enamel coating is formed on the transparent substrate including a multilayer thin film coating.

TABLE 1

| | SiO₂ | B₂O₃ | Bi₂O₃ | Al₂O₃ | ZnO |
|---|---|---|---|---|---|
| | (wt %) | (wt %) | (wt %) | (wt %) | (wt %) |
| Comparative | 9.5 | 8.1 | 69.3 | 2.0 | 11.0 |
| Example 1 | | | | | |
| Exemplary | 9.0 | 7.0 | 68.4 | 2.0 | 13.6 |
| Embodiment 1 | | | | | |

| | |
|---|---|
| Comparative | Composition + Black pigment of |
| Example 2 | Comparative Example 1 |
| Exemplary | Composition + Black pigment of |
| Embodiment 2 | Exemplary Embodiment 2 |

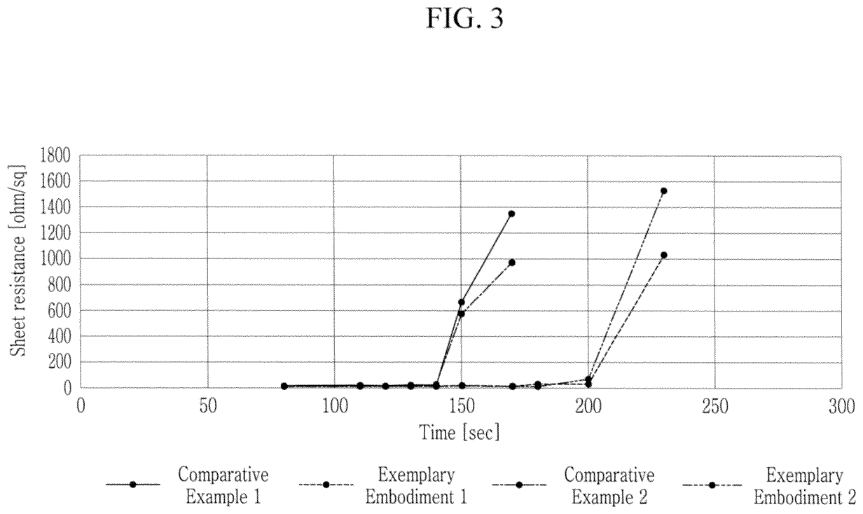

In this instance, in Exemplary Embodiments 1 and 2, when resistance is measured and the resistance becomes equal to or greater than 100 Ω/m², the heat treatment is immediately stopped (i.e., the heat treatment is stopped when the time becomes about 230 seconds as expressed in the graph of FIG. 3), and in Comparative Examples 1 and 2, when resistance is measured and the resistance becomes equal to or greater than 100 Ω/m², the heat treatment is further performed for about 80 seconds. That is, as expressed in the graph of FIG. 3, in the case of Comparative Examples 1 and 2, the resistance is steeply increased at the point of about 150 seconds, and the heat treatment is continued without stopping it, so the heat treatment is performed for 230 seconds being consistent with Exemplary Embodiments 1 and 2.

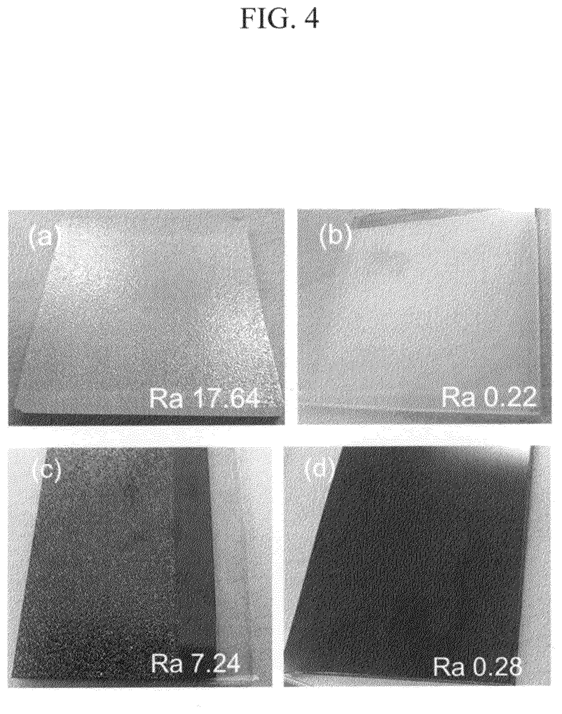

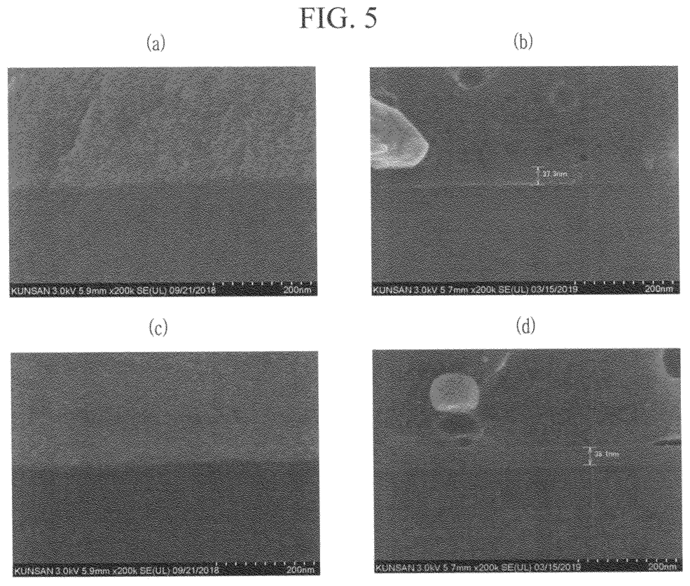

A layer structure of the enamel coating 30, surface roughness, and surface photographed results acquired by the exemplary embodiments and the Comparative Examples are shown in Table 2, FIG. 4, and FIG. 5. Remaining of the layer of Si₃N₄ between the enamel coating and the transparent substrate may be confirmed by the SEM image of FIG. 5.

TABLE 2

| | Remaining state | | | |
|---|---|---|---|---|
| | of Si₃N₄ | | | |
| | between enamel | Surface | Evaluation | SEM |
| | coating and | roughness | photo of | photo of |
| | transparent substrate | (μm) | FIG. 4 | FIG. 5 |
| Comparative | X | 17.64 | (a) | (a) |
| Example 1 | | | | |
| Exemplary | ◯ | 0.22 | (b) | (b) |
| Embodiment 1 | | | | |
| Comparative | X | 7.24 | (c) | (c) |
| Example 2 | | | | |
| Exemplary | ◯ | 0.28 | (d) | (d) |
| Embodiment 2 | | | | |

As expressed in Table 2, FIG. 4, and FIG. 5, it is found that Si₃N₄ (a first dielectric layer) remains (the first dielectric layer that is about 37.3 nm and 38.1 nm thick remains between the enamel coating and the transparent substrate) in the case of Exemplary Embodiments 1 and 2 in which the heat treatment is immediately stopped when resistance of the multilayer thin film coating becomes equal to or greater than 100 Ω/m², and the surface roughness of the enamel coating is less than 0.5 μm, showing excellent surface quality. On the contrary, it is confirmed in Comparative Examples 1 and 2 that, as shown in FIG. 5, the multilayer thin film coating is removed without remaining of the first dielectric layer, and the surface roughness of the enamel coating obtained in this case is very high. That is, according to the exemplary embodiments of the present invention, Si₃N₄ (the first dielectric layer) remains between the enamel coating and the transparent substrate and the surface roughness of the enamel coating is improved.

The present invention is not limited to the exemplary embodiments and may be produced in various forms, and it will be understood by those skilled in the art to which the present invention pertains that exemplary embodiments of the present invention may be implemented in other specific forms without modifying the technical spirit or essential features of the present invention. Therefore, it should be understood that the aforementioned exemplary embodiments are illustrative in terms of all aspects and are not limited.

### DESCRIPTION OF SYMBOLS

10: transparent substrate
20: multilayer thin film coating
30: enamel coating
PA: patterned area
201: first dielectric layer
202: second dielectric layer
210: metallic functional layer
221, 222: blocking layer
100: coated article

1. A coated article comprising
a transparent substrate, a multilayer thin film coating disposed on the transparent substrate, and a patterned area having an enamel coating formed on at least part of the transparent substrate in a predetermined pattern,
wherein the multilayer thin film coating includes a first dielectric layer, a metallic functional layer having an infrared ray reflection function, and a second dielectric layer, which are sequentially disposed in a direction away from the transparent substrate, and
the patterned area includes the first dielectric layer remaining on the transparent substrate after the second dielectric layer and the metallic functional layer are removed from the multilayer thin film coating and the enamel coating formed on the first dielectric layer.

2. The coated article as claimed in claim 1, wherein
the multilayer thin film coating includes a blocking layer laminated on at least one of an upper surface and a lower surface of the metallic functional layer to prevent oxidation of the metallic functional layer.

3. The coated article as claimed in claim 1, wherein
the first dielectric layer included in the patterned area prevents diffusion of sodium ions from the transparent substrate.

4. The coated article as claimed in claim 1, wherein
the first dielectric layer includes a silicon nitride.

5. The coated article as claimed in claim 1, wherein
the enamel coating has a surface roughness less than 0.5 μm.

6. The coated article as claimed in claim 1, wherein
the enamel coating includes at least one metal selected from Bi and Zn.

7. The coated article as claimed in claim 1, wherein
the enamel coating includes a black pigment.

8. A manufacturing method of a coated article, comprising:
printing a composition for forming an enamel coating to have a predetermined pattern on at least part of a transparent substrate on which a multilayer thin film coating is formed; and
forming a patterned area including an enamel coating by performing a heat treatment on the transparent substrate on which the multilayer thin film coating and the composition for forming an enamel coating are formed,
wherein the multilayer thin film coating includes a first dielectric layer, a metallic functional layer having an infrared ray reflection function, and a second dielectric layer in a direction away from the transparent substrate,
the metallic functional layer and the second dielectric layer are removed from a portion on which the patterned area is formed by the heat treatment, and the first dielectric layer remains between the enamel coating and the transparent substrate.

9. The manufacturing method as claimed in claim 8, wherein
the multilayer thin film coating further includes a blocking layer laminated on at least one of an upper surface and a lower surface of the metallic functional layer to prevent oxidation of the metallic functional layer.

10. The manufacturing method as claimed in claim 8, wherein
the heat treatment is carried out at a temperature of 500° C. to 720° C.

11. The manufacturing method as claimed in claim 8, wherein
the composition for forming an enamel coating includes a metal oxide with etching performance on the metallic functional layer.

12. The manufacturing method as claimed in claim 11,
wherein the metal oxide is at least one selected from Bi₂O₃ and ZnO.

13. The manufacturing method as claimed in claim 12, wherein
the metal oxide is Bi₂O₃, and a content of Bi₂O₃ is 55 wt % to 69 wt % in the entire glass frit included in the composition for forming an enamel coating.

14. The manufacturing method as claimed in claim 8, comprising
measuring resistance of the metallic functional layer so as to confirm removal of the metallic functional layer during the heat treatment, and stopping the heat treatment when resistance of the metallic functional layer is equal to or greater than 100 Ω/m².

15. The manufacturing method as claimed in claim 8, further comprising
drying and preheating the composition for forming an enamel coating before the heat treatment.

16. The manufacturing method as claimed in claim 8, wherein
the heat treatment is a tempering process of the transparent substrate.

17. A coated article manufactured by the method of claim 9.
